(19) United States
(12) Patent Application Publication
(10) Pub. No.: US 2021/0261034 A1
(43) Pub. Date: Aug. 26, 2021

(54) CARGO TRAILER APPARATUS

(71) Applicant: TMI Trailer Mechanic International SA CV, El Marques (MX)

(72) Inventor: Rodrigo SOTO, Queretaro (MX)

(73) Assignee: TMI Trailer Mechanic International SA CV, El Marques (MX)

(21) Appl. No.: 17/165,111

(22) Filed: Feb. 2, 2021

Related U.S. Application Data
(60) Provisional application No. 62/980,841, filed on Feb. 24, 2020.

(51) Int. Cl. B60P 1/52; B62D 35/02

(52) U.S. Cl. CPC B60P 1/52; B62D 35/02

(57) ABSTRACT

A cargo trailer apparatus is provided. In another aspect, aerodynamic fairings for a cargo trailer are provided. A further aspect employs a cover or fairing, including a curved external surface, attached to a trailer frame below a horizontal plane defined by a top floor surface. Yet another aspect employs a cover or fairing attached to a trailer frame below a floor and behind wheels of the trailer. In another aspect, a pallet or cargo carrier includes a cargo-carrying top surface and roller-engaging channels or guides projecting from a bottom surface. In another aspect, sets of fore-and-aft rollers are mounted to a floor of a wheeled trailer, with the roller sets being laterally spaced apart, and a cargo carrier includes laterally spaced apart structures which move over the rollers while deterring misalignment of the carrier as it is manually slid over the rollers.

### CROSS-REFERENCE

The present application claims priority to U.S. provisional patent application Ser. No. 62/980,841, filed on Feb. 24, 2020, which is incorporated by reference herein.

### BACKGROUND AND SUMMARY

The present disclosure relates generally to a cargo trailer apparatus, and more particularly to aerodynamic fairings and a roller-pallet device for cargo trailers.

Aerodynamic fairings have been attached to lower sides and over rear doors of truck trailers. Examples of such traditional devices are disclosed in U.S. Pat. No. 9,919,749 entitled “Side Skirt System for a Trailer” which issued to Baker et al. on Mar. 20, 2018; U.S. Pat. No. 9,090,294 entitled “Aerodynamic Fairings for Trailers” which issued to Johnson et al. on Jul. 28, 2015; U.S. Pat. No. 8,979,172 entitled “Vehicle Side Fairing System” which issued to Reiman et al. on Mar. 17, 2015; and U.S. Pat. No. 8,100,461 entitled “Rear-Mounted Aerodynamic Structure for Truck Cargo Bodies” which issued to Smith et al. on Jan. 24, 2012. These patents are incorporated by reference herein. While these conventional devices improve air flow in their limited areas, there is still a need for aerodynamic improvements underneath the trailer.

Truck box-trailers are typically loaded by a fork lift truck entering the trailer and placing a pallet containing cargo onto a flat wooden floor or deck, which requires a raised loading dock and a fork lift truck. But the loaded pallets are difficult to manually move inside the trailer thereafter. Alternately cargo loading and shifting is done by manual lifting and moving individual boxes inside the trailer, which is very labor intensive, strenuous and time consuming. Complicated attempts to employ full-width rollers have been envisioned in U.S. Pat. No. 5,478,190 entitled “Roll-Off Trailer with Cargo Controlling Mechanism” which issued to Helton on Dec. 26, 1995; and U.S. Pat. No. 5,395,204 entitled “Truck Trailer Unloading Apparatus” which issued to Balik on Mar. 7, 1995; both of which are incorporated by reference herein, However, these devices are overly complex and not well suited for manual rearrangement of pallets within the trailer.

In accordance with the present invention, a cargo trailer apparatus is provided. In another aspect, aerodynamic fairings for a cargo trailer are provided. A further aspect employs a cover or fairing, including a curved external surface, attached to a trailer frame below a horizontal plane defined by a top floor surface. Yet another aspect employs a cover or fairing attached to a trailer frame below a floor and behind wheels of the trailer.

In another aspect, a pallet or cargo carrier includes a cargo-carrying top surface and roller-engaging channels or guides projecting from a bottom surface. In another aspect, sets of fore-and-aft rollers are mounted to a floor of a wheeled trailer, with the roller sets being laterally spaced apart, and a cargo carrier includes laterally spaced apart structures which move over the rollers while deterring misalignment of the carrier as it is manually slid over the rollers. A further aspect uses a cargo carrier that has a lateral width that is within at least 90% of an internal box-trailer width, and which can be manually pushed along rollers within the box-trailer in a fore-and-aft direction. Additional advantages and features of the present apparatus can be ascertained from the following description and appended claims, taken in conjunction with the accompanying drawings.

### BRIEF DESCRIPTION OF THE DRAWINGS

FIG. 1 is a perspective view showing the present cargo trailer apparatus;

FIG. 2 is a fragmentary and partially exploded perspective view showing the present cargo trailer apparatus;

FIG. 3 is a fragmentary side elevational view showing a fairing of the present cargo trailer apparatus;

FIG. 4 is a perspective view showing the fairing of the present cargo trailer apparatus;

FIG. 5 is a partially exploded perspective view showing multiple fairings of the present cargo trailer apparatus;

FIG. 6 is a side elevational view showing a central fairing of the present cargo trailer apparatus;

FIG. 7 is a fragmentary top elevational view showing the central fairing of the present cargo trailer apparatus;

FIG. 8 is a fragmentary top elevational view showing outer extension fairings of the present cargo trailer apparatus;

FIG. 9 is a fragmentary perspective view showing a pallet and roller feature of the present cargo trailer apparatus;

FIG. 10 is a perspective view showing the pallet of the present cargo trailer apparatus;

FIG. 11 is a top elevational view showing the pallet of the present cargo trailer apparatus;

FIG. 12 is a rear elevational view showing the pallet of the present cargo trailer apparatus;

FIG. 13 is an enlarged rear elevational view, taken within circle 13 of FIG. 12, showing the pallet of the present cargo trailer apparatus; and

FIG. 14 is a side elevational view showing the pallet of the present cargo trailer apparatus.

### DETAILED DESCRIPTION

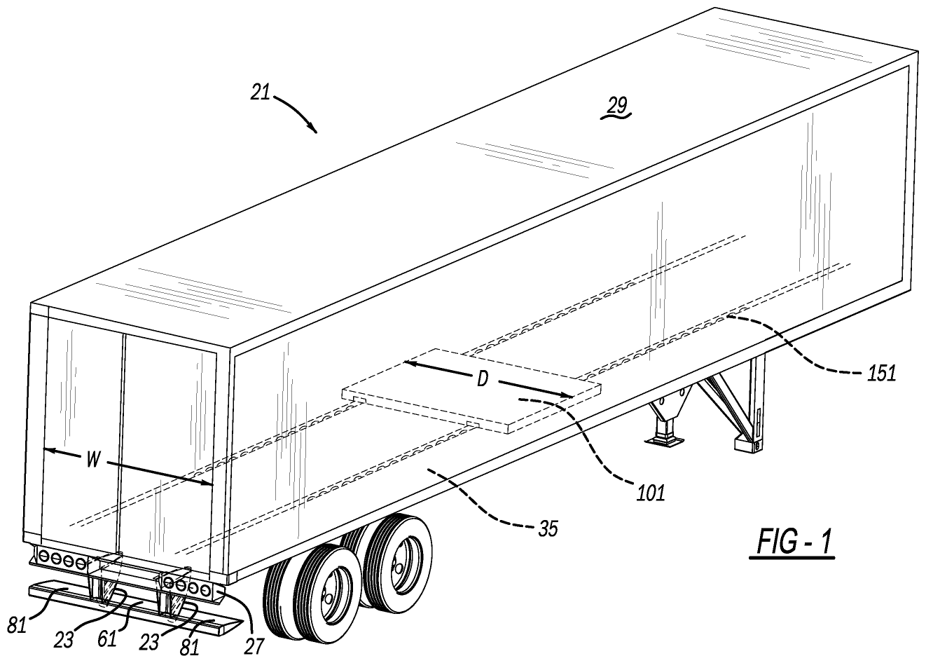

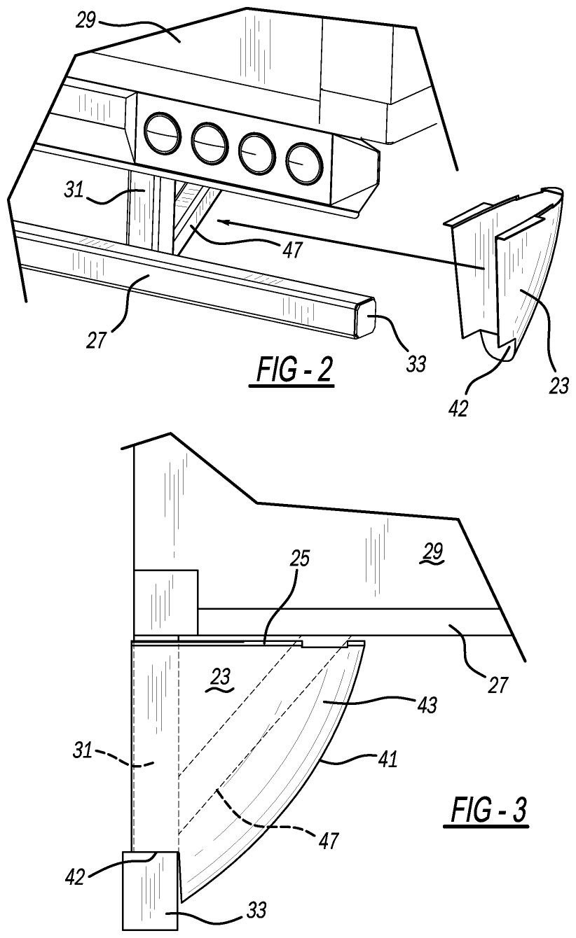

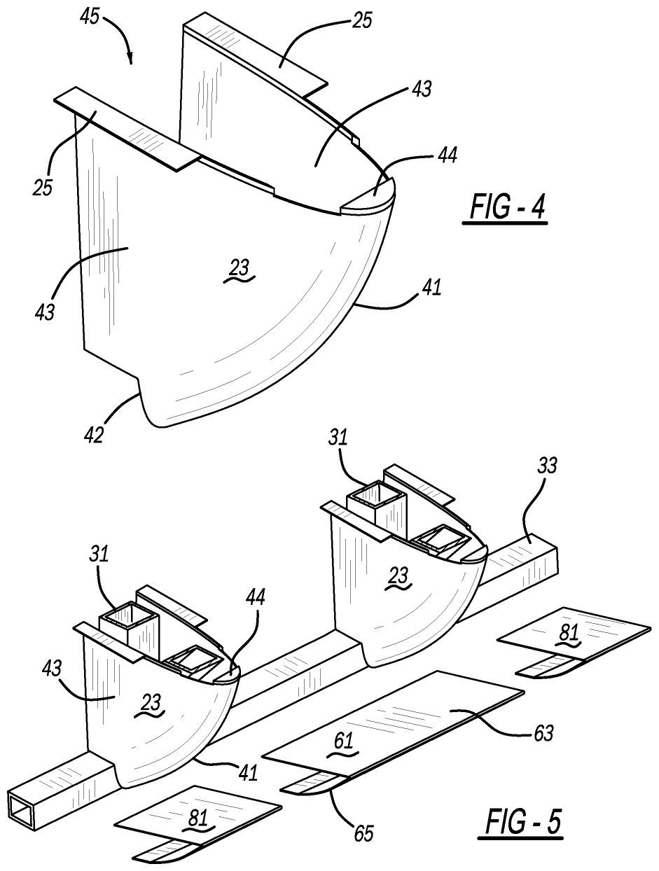

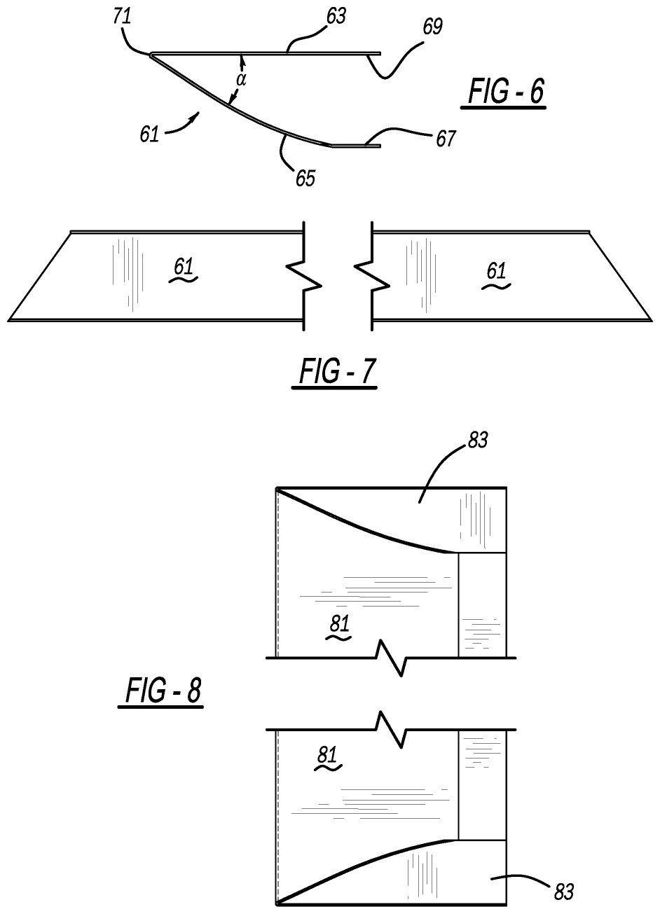

A preferred embodiment of a trailer apparatus 21 includes aerodynamic fairings 23 as can be observed in FIGS. 1-8. A pair of generally vertically extending fairings 23 (see FIGS. 2-5) are preferably polymeric injection molded parts that contain flanges 25 screwed, riveted or otherwise fastened to a structural metallic frame 27 of a cargo-carrying box-trailer 29. The frame includes vertical posts 31, joined by a horizontally and laterally elongated crossing post 33, all of which are below a horizontal plane defined by a top floor surface 35 of the trailer. A pair of the vertical fairings are located on their respective vertical frame posts in a spaced apart manner as illustrated is in FIGS. 1 and 2.

A front edge or nose 41 of each vertical fairing has an arcuately curved shape in a side view, and also a curved top view shape which transitions into much larger radius curved side walls 43. The side view of the vertical fairing is curved and somewhat triangular with a smaller end at the bottom. A center 45, between the side walls is hollow to allow positioning over a structural, diagonal brace 47 of the frame. The greatest fore-and-after dimension of each vertical fairing is at a top thereof adjacent an underside of the trailer floor.

Each fairing 23 also includes a squared off notch 42 at a lower rear corner thereof to contact against both upper and forward surfaces of crossing post 33, thereby providing a secure perpendicular two-surface fit. Moreover, a substantially flat and horizontal ledge 44 spans across a top of nose 41 of each fairing 23; this ledge 44 contacts against a front surface of diagonal brace 47 when attached. Ledge 44 is generally co-planar with flanges 25.

FIGS. 5-7 show a central aerodynamic fairing 61 which is mounted to a forward (and/or alternately rearward) side of the horizontal crossing post 33 of the trailer 29 between the vertical posts 31. The flat and laterally elongated surface of the central fairing is a top surface 63 which is generally parallel to the trailer floor 35, and the tapered surface 65 is at the bottom. The taper 65 is preferably arcuately curved but may be straight. A flat flange section 67 is fastened to the post 33 as is a section 69 adjacent to an edge on the flat top 63. The tapered and flat top surfaces intersect at a nose 71 which has a tight radius with an acute angle x. The nose 71 is forwardly facing and reduces wind turbulence in use.

FIGS. 1 and 8 show left and right extension fairings 81 which are similar to the central fairing, but mounted to portions of the horizontal crossing post which are laterally outboard of the vertical posts. An outboard tapered side wall 83 may optionally be present on each of these extension fairings 81. The central and extension fairings are preferably galvanized stamped, sheet steel but may alternately be polymeric.

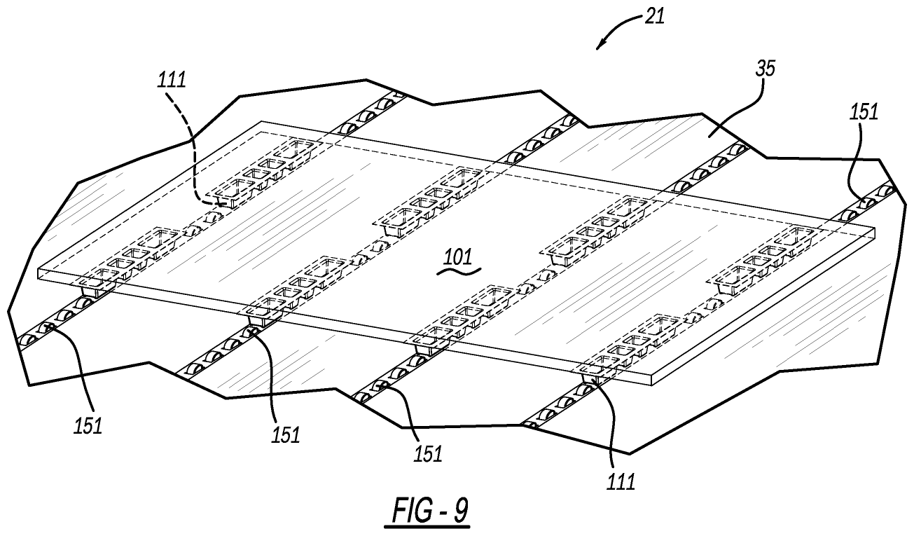

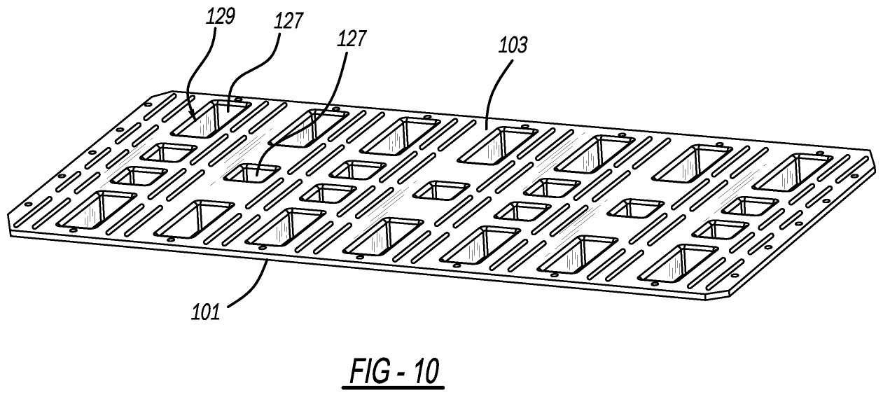

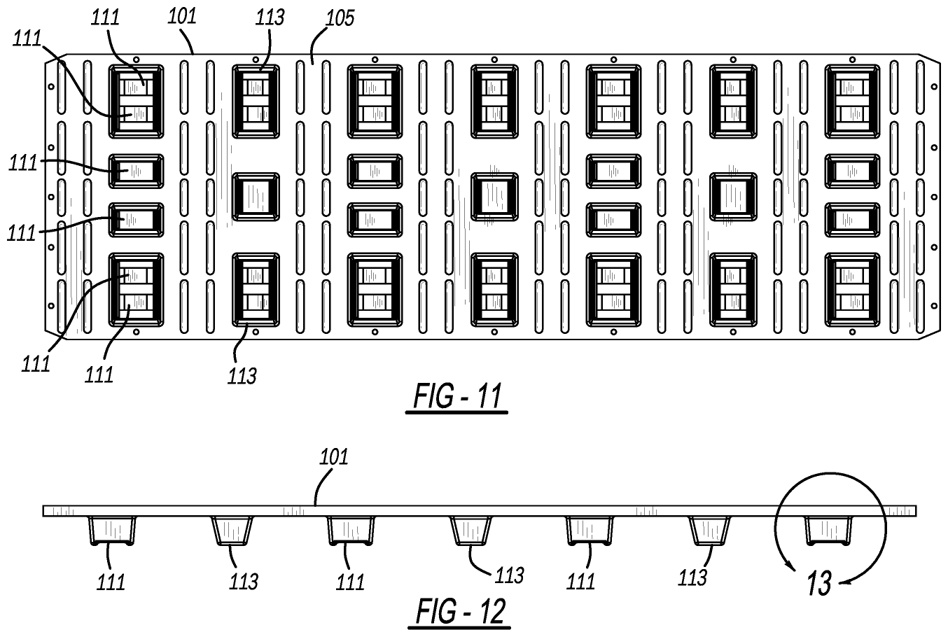

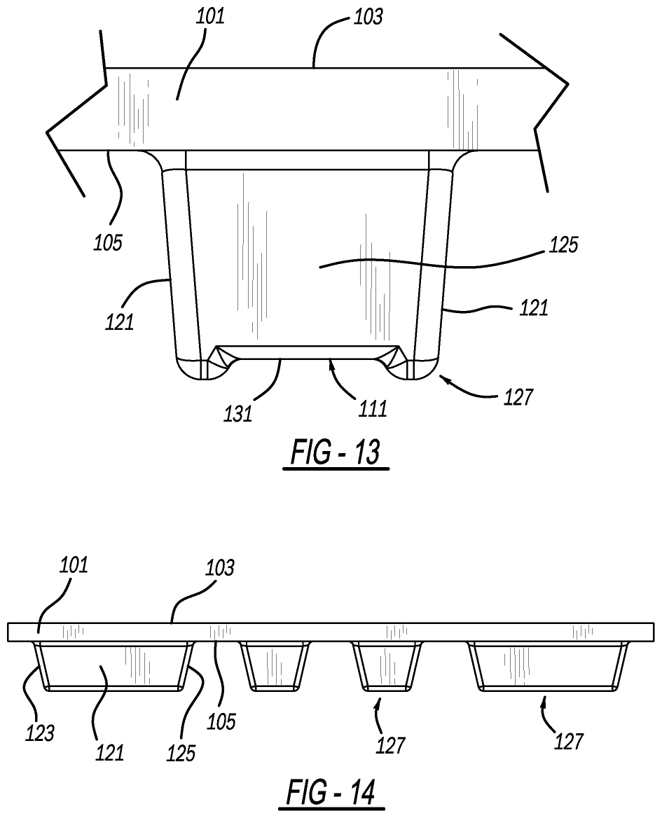

Referring now to FIGS. 9-14, the trailer apparatus 21 includes a cargo-carrying pallet 101 which is preferably injection molded or thermoformed from a polymeric material. A flat upper surface 103 supports boxes or other cargo temporarily retained thereon. A lower surface 105 includes rows of spaced apart roller-receiving channels or guides 111 (see FIG. 13) that alternate with rows of narrower width reinforcement structures 113, all of which downwardly project from the nominally flat lower surface 105. The hollow channels 111 include tapered lateral side walls 121, which are elongated in a fore-and-after direction, joined by front and rear walls 123 and 125, respectively, that form a box-like member 127 with an open top 129. A depression 131 extends in a fore-and-aft direction in a center of each channel 111. The depression of each channel is open at the front and rear thereof. At least one, and in some rows two, fore-and-aft smaller dimensioned box-like members 127 with channels 111, alternate with longer fore-and-aft dimensioned box-like members 127, for each pallet. This central depression and extending side segment configuration create a generally inverted U-shape when viewed from behind like in FIG. 13. The pallet 101 may be an integral single piece or multiple pieces fastened together.

Multiple spaced apart rows of rollers 151 are secured to the floor 35 of the trailer 29 and are upwardly exposed therein as can be observed in FIG. 9. The channels 111 contact against the roller sets 151 such that the depressed centers 131 ride on top of the upper surfaces of the rollers while the extending side wall segments 121 contact against lateral sides or corners of the rollers. This interaction of the pallet channels to the rollers deters misalignment and jamming as the pallet 101 is manually slid into and out of the box-trailer 29, and moved at any fore-and-after position within the trailer interior. Each pallet preferably has a lateral peripheral dimension D at least 90% of an interior lateral width W of the trailer; the roller and pallet configuration allow for this closer fit. It is envisioned that only 13 of the present pallets are needed as compared to the use of 24 pallets with traditional trailers and pallets, when full.

While various embodiments have been disclosed, other variations are envisioned. For example, four rows of the present roller-channels are illustrated, however, at least two fore-and-after extending rows can be employed but six or more may be used, although some of the present advantages may not be realized. Furthermore, the central and extension fairings may be combined as a single integral piece. These fairings may alternately be located on other generally vertical and/or horizontal frame components although some of the present benefits may not be achieved. Moreover, a method of making, installing and/or using the present apparatus is also envisioned. It should be appreciated that features of one embodiment may be interchanged with features of another embodiment in any combination and order. Variations are not to be regarded as a departure from the present disclosure and all such modifications are intended to fall within the scope of the present invention.

The invention claimed is:

1. A cargo trailer apparatus comprising a cargo-carrier comprising:
an upper cargo-carrying surface;
a lower surface; and
multiple, spaced apart, roller-receiving channels projecting from the lower surface, each of the channels including lateral side segments and a central depression extending in a fore-aft direction, and the side segments and the central depression creating a substantially inverted U-shape for each of the channels.

2. The apparatus of claim 1, wherein the cargo-carrier comprises multiple parallel rows of hollow box-members including the channels on a bottom thereof, at least two of the box-members being located in each of the rows.

3. The apparatus of claim 2, wherein each of the box-members is upwardly open and includes curved external corners.

4. The apparatus of claim 2, wherein fore-and-aft smaller of the box-members, with the depression therein, alternate with fore-and-aft longer of the box-members, with the depression therein.

5. The apparatus of claim 1, wherein the channels and laterally lower extending side segments are configured to contact against top and side surfaces of a fore-and-aft set of trailer rollers to align the cargo-carrier with an interior trailer width as it is being slid fore-and-aft within the trailer and to deter misalignment and jamming while the cargo-carrier is being slid.

6. The apparatus of claim 5, wherein a lateral peripheral dimension of the cargo-carrier is at least 90% of the interior trailer width.

7. The apparatus of claim 1, wherein:
the upper cargo-carrying surface of the cargo-carrier is substantially flat;
a lateral peripheral dimension of the cargo-carrier is at least twice that of a fore-and-aft peripheral dimension of the cargo-carrier; and
the cargo-carrier is polymeric.

8. A cargo trailer apparatus comprising:
(a) a cargo box trailer comprising:
a floor having a lateral dimension;
multiple sets of rollers laterally spaced apart on the floor;
each of the sets of rollers extending a majority of a fore-and-aft length of the floor;
(b) a cargo-carrying pallet comprising:
an upper cargo-carrying surface;
a lower surface;
an outer edge joining the upper and lower surfaces;
multiple parallel rows of hollow box-members including side walls downwardly projecting from the lower surface with channels being raised above bottoms of and positioned between the side walls, each of the channels;
(c) the channels and laterally lower extending side walls of each of the box-members operably contacting against top and side surfaces of the rollers to align the pallet within the trailer as it is being slid fore-and-aft and to deter misalignment and jamming of the pallet as it is being slid; and
(d) a lateral edge dimension of the pallet is at least 90% of the interior trailer width.

9. The apparatus of claim 8, wherein:
the upper cargo-carrying surface of the pallet is substantially flat;
a lateral edge dimension of pallet is at least twice that of a fore-and-aft edge dimension of the pallet; and
the pallet is polymeric.

10. The apparatus of claim 8, wherein the pallet further comprises multiple parallel rows of substantially flat bottomed projections extending from the lower surface of the pallet, the flat bottomed projections laterally alternating between pairs of the rows of the box-members, and at least two of the box-members being located in each of the rows.

11. The apparatus of claim 8, wherein each of the box-members is upwardly open and includes curved external corners.

12. The apparatus of claim 8, further comprising an aerodynamic fairing including:
a curved nose;
walls which intersect at the nose creating an acute angle between the walls when viewed in cross-section;
a hollow area being located between the walls; and
a flange extending from the walls being adapted for fastening to a frame of the trailer below a floor plane of the trailer.

13. A cargo trailer apparatus comprising an aerodynamic fairing including:
a curved nose;
walls which intersect at the nose creating an acute angle between the walls when viewed in cross-section;
a hollow area being located between the walls; and
a flange extending from the walls being adapted for fastening to a frame of the trailer below a floor plane of the trailer.

14. The trailer apparatus of claim 13, wherein the frame comprises vertical posts and a horizontally crossing post intersecting the vertical posts, the vertical and crossing posts all being below the trailer floor plane and behind wheels of the trailer.

15. The trailer apparatus of claim 14, wherein the fairing is vertically elongated and has a substantially curved, triangular side view shape, and the fairing is attached to the vertical post of the frame.

16. The trailer apparatus of claim 15, wherein the fairing includes a notch in a bottom corner thereof configured to receive and contact again upper and front surfaces of a horizontal crossing beam of a trailer.

17. The trailer apparatus of claim 15, wherein an internal hollow of the fairing encloses side and front surfaces of a diagonal brace of the trailer frame below the floor plane.

18. The trailer apparatus of claim 14, wherein one of the walls of the fairing is substantially flat and substantially parallel to the trailer floor, and the fairing is attached to the crossing post of the frame.

19. The trailer apparatus of claim 18, wherein the fairing is located between vertically extending posts of the trailer frame.

20. The trailer apparatus of claim 19, further comprising outboard fairings located laterally outboard of the vertically extending posts, the outboard fairings being attached to the crossing post of the frame, and the outboard fairings each including a tapered outside wall spanning between the flat wall which is an upper and horizontal wall.
